(19) United States
(12) Patent Application Publication
(10) Pub. No.: US 2025/0203458 A1
(43) Pub. Date: Jun. 19, 2025

(54) METHOD AND APPARATUS FOR NETWORK LOAD BALANCING USING MULTIPLE SESSIONS

(71) Applicant: KT CORPORATION, Gyeonggi-do (KR)

(72) Inventors: Kun-Woo PARK, Gyeonggi-do (KR); Sang-Hun KIM, Gyeonggi-do (KR); Se-Hoon KIM, Gyeonggi-do (KR); Il-Yong KIM, Gyeonggi-do (KR)

(73) Assignee: KT CORPORATION, Gyeonggi-do (KR)

(21) Appl. No.: 18/981,024

(22) Filed: Dec. 13, 2024

(30) Foreign Application Priority Data
Dec. 13, 2023 (KR) 10-2023-0180943

(51) Int. Cl. H04W 28/086; H04L 43/0882; H04W 76/15

(52) U.S. Cl. CPC H04W 28/0861; H04L 43/0882; H04W 76/15

(57) ABSTRACT

Provided are a method and apparatus in a core network for balancing a network load. The method may include: classifying each of multiple sessions of a user equipment (UE) established through base stations into an active session and a standby session based on traffic load of a corresponding base station, wherein the UE establishes multiple sessions to the core network, and the base stations includes a first base station and a second base station; generating session priority information of each session according to the classification result; and transmitting the session priority information of each session to the UE and at least one user plane function (UPF) connected to each session, wherein the UE transmits data to and receive data from the core network using the active session among the multiple sessions established between the UE to the core network.

### BACKGROUND

The disclosure relates to network load balancing using multiple sessions. In particular, the disclosure relates to a method and apparatus for distributing and managing network load using multiple sessions established between user equipment to a core network.

A User Equipment (UE) connects to a 5G core network through a base station (gNB), establishes a session to corresponding user plane function (UPF), and connects to a 5G Standalone (SA) network through the established session. From the connected 5G SA network, the UE receives the desired communication services.

Typically, the User Equipment (UE) establishes traffic sessions directly with the base station (gNB) and the User Plane Function (UPF). Therefore, to provide communication services to a large number of UEs, multiple base stations and UPFs are deployed across a wide area. However, core network equipment, such as the Access and Mobility Management Function (AMF) and the Session Management Function (SMF), which manage radio resources and sessions, are concentrated in specific regions to manage a large number of associated base stations and UPFs.

Therefore, single User Equipment (UE) may connect multiple different base stations (gNBs) and UPFs as it moves or depends on the communication environment. However, the core network equipment, such as the AMF and SMF, located in central facilities, must remain the same until the session is deleted and re-established.

In such situations, when multiple User Equipment (UE) connect to a specific base station and core network equipment, limited radio and core resources must be shared among the UEs. Therefore, the performance of the UEs and the stability of the service can be affected by the specific base station and core network equipment.

To provide communication services to more User Equipment (UE) and prevent multiple UEs from connecting to a specific base station and core network equipment, the system's capacity can be increased by expanding physical radio and core systems. However, this approach leads to high investment costs, which increase the price burden on consumers.

### SUMMARY

In accordance with an aspect of the disclosure, data traffic concentrated on a specific gNB or UPF may be recognized, and the concentrated data traffic may be distributed by managing multiples sessions established between UEs to a core network.

In accordance with another aspect of the disclosure, multiple sessions established from one UE to a core network are classified as an active session and a standby session based on the traffic load of an associated base station, the traffic load of the associated base station connected with the active session is continuously monitored, and the active session and the standby session may be switched based on the monitoring results.

In accordance with further another aspect of the disclosure, redundant transmission scheme, defined in 3GPP release 16, may be used for balancing a network load in a 5G standalone (SA) UE route selection policy (URSP) based wireless and core network.

In accordance with an embodiment, a method of a user data repository (UDR) in a core network may be provided for balancing a network load. The method may include: classifying each of multiple sessions of a user equipment (UE) established through base stations into an active session and a standby session based on traffic load of a corresponding base station, wherein the UE establishes multiple sessions to the core network, and the base stations includes a first base station and a second base station; generating session priority information of each session according to the classification result; and transmitting the session priority information of each session to the UE and at least one user plane function (UPF) connected to each session, wherein the UE transmits data to and receive data from the core network using the active session among the multiple sessions established between the UE to the core network.

The method may further include: monitoring a traffic load of the first base station in an event of classifying a session connected through the first base station into an active session and another session connected through the second base station into a standby session; in an event that the traffic load of the first base station exceeds a predetermined threshold, changing the active session connected to the first base station to a standby session, and changing the standby session of the second base station to an active session; and updating the session priority information based on the changes and transmitting the updated session priority information to the UE and the at least one UPF.

The method may further include: transmitting the session priority information to policy control function (PCF) in the core network, wherein the PCF sets a traffic forwarding policy based on the session priority information for a user plane function (UPF) connected to the active session, sets a traffic drop policy based on the session priority information for another UPF connected to the standby session, and transmits the traffic forwarding policy and the traffic drop policy to the UPFs.

The UDR receives the traffic usages of the first base station or the second base setation according to the traffic forwarding policy from one UPF connected through the active session and monitor whether the traffic usage of each base station exceeds the predetermined threshold.

The session priority information is transmitted to access and mobility management function (AMF) through the UDR and a session management function (SMF); and the AMF, upon receiving the priority information, triggers a UE policy negotiation update operation to transmit the session priority information to the UE.

In accordance with another embodiment, a method of a user plane function (UPF) in a core network may be provided for balancing a network load. The method may include: receiving a traffic forwarding policy from a policy control function (PCF) where the traffic forwarding policy is set by the PCF based on session priority information configured by a user data repository (UDR); and monitoring a traffic usage of a base station connected to a user equipment (UE) through the active session and transmitting the monitored traffic usage to the PCF, wherein when the UE establishes multiple sessions through two different base stations, the session priority information is information distinguishing the multiple sessions into an active session used for transmitting and receiving data and a standby session.

The session priority information is generated by classifying each of multiple sessions of the UE established through base stations into an active session and a standby session based on traffic load of a corresponding base station, wherein the UE establishes multiple sessions to the core network, and the base stations includes a first base station and a second base station.

The method may further include: receiving a traffic drop policy from the PCF, wherein the traffic drop policy is set according to session priority information changed based on the traffic usage; and upon receiving the traffic drop policy, stopping the monitoring of the traffic usages.

In accordance with further another embodiment, a method of a user equipment may be provided for balancing a network load in a core network. The method may include: establishing multiple sessions connected to a core network through at least two base stations including a first base station and a second base station; receiving session priority information from the core network; setting, as an active session, a session connected to the first base station among the multiple sessions based on the session priority information, and setting, as a standby session, a session connected to the second base station among the multiple sessions based on the session priority information; and transmitting data to and receiving data from a packet data network (PDN) through the active session.

The session priority information is configured based on traffic usages of the first base station and the second base station by user data repository (UDR).

The session priority information is included in a field of a UE route selection policy (URSP) that the UE receives.

The method may further include: receiving an updated session priority information in an event that the traffic usage of the first base station exceeds a predetermined threshold; and based on the updated session priority information, changing the session of the first base station to a standby session, and changing the session of the second to an active session.

The updated session priority information is included in a field in updated UE route selection policy (URSP) received from the core network.

The updated session priority information is received through UE policy negotiation update process from access and mobility management function (AMF).

### BRIEF DESCRIPTION OF THE DRAWINGS

FIG. 1 is a diagram illustrating network configuration providing load balancing according to an embodiment.

FIG. 2 is a flowchart illustrating a method for managing and distributing network load in accordance with an embodiment.

FIG. 3 is a diagram for explaining initially establishing an active session in accordance with an embodiment.

FIG. 4 is a diagram for explaining switching an active session to a standby session in accordance with an embodiment.

FIG. 5 illustrates a session establishment procedure according to an embodiment.

FIG. 6 illustrates an active session configuration procedure according to one embodiment.

FIG. 7 illustrates a standby session establishment procedure according to one embodiment.

FIG. 8 illustrates a procedure for modifying session priority based on traffic usage reporting according to one embodiment.

FIG. 9 illustrates a procedure for changing an active session to a standby session based on the modified session priority information according to one embodiment.

FIG. 10 illustrates the procedure for changing a standby session to an active session based on the modified session priority information according to one embodiment.

FIG. 11 is a block diagram illustrating the hardware configuration of a computing device according to one embodiment.

### DETAILED DESCRIPTION OF EMBODIMENTS

Below, the embodiments of this disclosure will be described in detail with reference to the attached drawings to enable those skilled in the art to easily implement the invention. However, this disclosure is not limited to the embodiments described herein and may be implemented in various forms. In the drawings, parts irrelevant to the explanation are omitted for clarity, and similar reference numerals are used to indicate similar parts throughout the specification.

In the disclosure, the User Equipment (UE) refers to a terminal that connects to a base station in the Access Network (AN) or Radio Access Network (RAN) and utilizes the Network Functions (NFs) of the Core Network (CN). The User Equipment (UE) may take various forms and purposes, such as a mobile terminal, Internet of Things (IoT) device, vehicle terminal, display terminal, broadcasting terminal, or gaming terminal. For example, the UE may include a smart phone and a tablet. The base station may include Evolved Node B (eNB), Next-Generation Node B (gNB), Access point (AP), or other types depending on the access network. Devices that make up the network can be implemented as hardware, software, or a combination of hardware and software.

The embodiments of the disclosure are supported by standard documents related to the 3GPP (3rd Generation Partnership Project) 5G system, such as FS_NextGen (Study on Architecture for Next Generation System). That is, steps or parts not explicitly described in the embodiments of this disclosure to clarify the technical concept of the embodiments may be supported by the aforementioned documents. Furthermore, all terms disclosed in this disclosure may be interpreted as defined in these standard documents.

According to the disclosure, when a User Equipment (UE) establishes multiple sessions with the core network through different base stations, the established sessions are classified into active and standby sessions, and data traffic between the UE and the core network is managed according to the established sessions. Furthermore, the traffic load on the base station connected through the active session is monitored, and the traffic load is balanced based on the monitoring result, for example, by switching the active session to a standby session and vice versa if the load of the base station associated with the active session exceeds a predetermined threshold.

Hereinafter, a load balancing method and apparatus will be described with reference to the accompanying drawings.

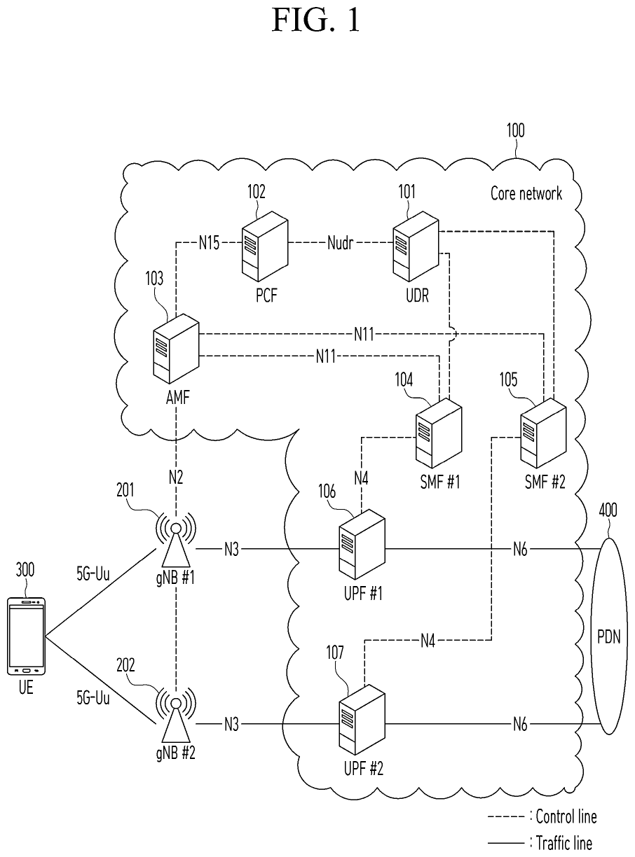

FIG. 1 is a diagram illustrating network configuration for managing and balancing network load according to an embodiment.

Referring to FIG. 1, core network 100 may be a 5G core network that provides communication services to User Equipment (UE) by performing key functions such as connection management, data routing, authentication, and policy control. For convenience of description and ease of understanding, core network 100 may be described as a 5G core network, but the embodiments are not limited thereto. For example, core network 100 may be 4G core network or LTE core network, so forth. Furthermore, the concepts of communication technologies and network device configurations used in a 5G communication system may be referenced in the embodiments of the disclosure.

In accordance with an embodiment, core network 100 may include functional nodes (e.g., network functions), such as UDR 101, PCF 102, AMF 103, first SMF (SMF #1) 104, second SMF (SMF #2) 105, first UPF (UPF #1) 106, second UPF (UPF #2) 107. Each functional node may be an independent entity implemented on at least one physical or virtual computer server equipped with predefined software applications.

Hereinafter, each function node will be briefly described. Unified Data Repository (UDR) 101 may store and manage subscriber information of UE 300, perform location registration, and conduct subscriber authentication. UDR may be referred to as Unified Data Management (UDM). In a 5G Core Network, the Unified Data Repository (UDR) is a key component that acts as a centralized database. It stores and manages subscription data, policy data, and other network-related information used by various network functions. The UDR allows different network functions, like the Authentication Server Function (AUSF), Policy Control Function (PCF), and Session Management Function (SMF), to access consistent and reliable data. This centralization simplifies data management, enhances efficiency, and supports scalability in the 5G network, enabling features like personalized services, seamless connectivity, and advanced policy enforcement.

Policy Control Function (PCF) 102 may determine policies for session management and mobility management and delivers them to AMF 103 and SMF 104, 105, enabling appropriate mobility management, session management, and QoS management. In the 5G Core Network, the PCF plays a vital role in managing network policies and rules. Its key functions include i) Policy Decision: Determines policies for user sessions and services, such as Quality of Service (QoS), priority, and bandwidth allocation, ii) Resource Management: Ensures efficient utilization of network resources by setting and enforcing policies, iii) Integration with UDR: Retrieves user policy data from the Unified Data Repository (UDR) and applies it to the network, iv) Support for Other Network Functions: Provides policy information to functions like the Session Management Function (SMF) and Access and Mobility Management Function (AMF). The PCF is essential for enabling the flexibility and customized services that define the 5G network.

Access and Mobility Management Function (AMF) 130 may be a mobility management device. AMF 130 may manage the connection and mobility of the User Equipment (UE) through NAS (Non-Access Stratum) signaling in accordance with an embodiment. In the 5G Core Network, the AMF performs the following key roles: i) Access Management: Handles network registration, authentication, and connection setup for User Equipment (UE), ii) Mobility Management: Manages handover procedures to maintain seamless connectivity as the UE moves, iii) Signaling Handling: Processes control signaling between the UE and the network and coordinates communication with other network functions (NFs), iv) Data Distribution: Routes UE data to appropriate network functions for tasks like network slicing or policy enforcement. The AMF serves as the central gateway between the UE and the core network, ensuring smooth access and mobility support in 5G networks.

Session Management Function (SMF) 104, 105 may be a session management device. SMF 104, 105 may establish and manage sessions that connect UE 300 to the PDN (Packet Data Network) and allocates IP addresses to be used in the network accessed by UE 300. In the 5G Core Network, such a SMF is responsible for managing data sessions and ensuring efficient data flow between the network and the User Equipment (UE). Its key functions include: i) Session Management: Establishes, modifies, and terminates data sessions for UEs, ii) IP Address Allocation: Assigns IP addresses to UEs for communication, iii) Policy Enforcement: Implements network policies and Quality of Service (QoS) rules as determined by the Policy Control Function (PCF), iv) Interaction with UPF: Manages the User Plane Function (UPF) to route and forward user data effectively, and v) Roaming Support: Ensures seamless session continuity during roaming across different networks. The SMF is crucial for enabling efficient data handling and providing high-speed, reliable connectivity in 5G networks.

User Plane Function (UPF) 106, 107 may be a data gateway device. UPF 106, 107 may deliver downlink PDU (Protocol Data Unit) data from the PDN to UE 300 with which the session is connected, and forwards uplink PDU data from UE 300 to the PDN. Here, the PDN may be an internet network in accordance with an embodiment. In the 5G Core Network, the UPF is a key component responsible for handling user data traffic. The UPF operates on the user plane, which is the path that actual data (such as internet traffic, voice, and video) travels between the User Equipment (UE) and external networks. Key roles of the UPF include: i) Data Forwarding: Routes user data packets between the UE and the external network (e.g., the internet or other services), ii) Traffic Management: Enforces Quality of Service (QoS) policies and prioritizes traffic based on network rules, iii) Packet Inspection: Performs deep packet inspection for security, optimization, or service differentiation purposes, iv) Billing and Charging: Tracks data usage for billing or charging based on service policies, and v) Roaming Support: Facilitates data traffic routing for users while roaming across networks. The UPF is critical in providing high-performance, low-latency data transfer and ensuring efficient management of user traffic in 5G networks.

In accordance with an embodiment, UDR 101, PCF 102, UPF 106, 107, SMF 104, 105 may be computing systems implemented by a private company for performing operations for balancing a network load in 5G standalone SA network using UE route selection policy (URSP), defined in 3GPP Release 15 (TS 23 503) and redundant transmission scheme, defined in 3GPP Release 16 while respectively performing corresponding operations described above.

Using such network nodes in 5G core network 100, UE 300 may access 5G core network 100 to receive predetermined communication services through base stations, such as gNB 201 or gNB 202. In particular, UE 300 connects to first gNB (gNB #1) 201 and second gNB (gNB #1) 202, first gNB 201 may be connected to first UPF (UPF #1) 106 in 5G core network 100, and second gNB 202 may be connected to second UPF (UPF #2) 107 in 5G core network 100. That is, UE 300 may form multiple protocol data unit (PDU) sessions to 5G core network 100 through gNB (e.g., first gNB 201 and second gNB 202) and UPF (e.g., first UPF 106 and second UPF 107).

In order to receive predefined communication service from 5G core network 100, UE 300 may establish dual PDU sessions based on the redundant transmission scheme. In the disclosure, the embodiments will be described with UE establishing two sessions with the 5G core network through two gNBs. However, the embodiments are not limited thereto. This is solely for convenience of description and ease of understating. For example, UE may establish more than two sessions. Furthermore, in the disclosure, a PDU session will be referred to simply as a session.

In accordance with an embodiment, User Equipment (UE) 300 establishes two sessions to 5G core network 100, as shown in FIG. 1. In particular, UE 300 is simultaneously connected to gNB #1 201 and gNB #2 202 and is connected to UPF #1 106 and UPF #2 107 and establishes multiple PDU sessions in accordance with an embodiment.

For example, a first PDU session is established through Master gNB #1 201 and first UPF (UPF #1) 106, which acts as the session anchor, for UE 300. A second PDU session is established through secondary gNB #2 202 and second UPR (UPF #2) 107 for UE 300.

UE 300 may select two gNBs with relatively stronger signal strength (RSRP, Received Signal Received Power) measured from the surrounding environment, namely gNB #1 201 and gNB #2 202 and connect to the selected gNBs, such as gNB #1 201 and gNB #2 202.

At this time, the User Equipment (UE) 300 may designate the gNB with the strongest signal strength, gNB #1 201, as a Master gNB (e.g., first or primary gNB), and the gNB with the second strongest signal strength, gNB #2 202, as the Secondary gNB (e.g., second gNB). gNB #1 201 and gNB #2 202 share a single N2 interface with AMF 103. Additionally, gNB #1 201 and gNB #2 202 independently establish traffic tunnels through UPF #1 106 and UPF #2 107, respectively.

According to the embodiment, UE 300's dual sessions, for example, a first session: UE 300 -gNB #1 201 -UPF #1 106 and a second session: UE 300 -gNB #2 202 -UPF #2 107, may be managed as an active-standby structure for effectively distributing network load in 5G core network 100.

To manage the dual sessions of the User Equipment (UE) in an active-standby structure, each session is set to either an active or standby state. In order to indicate the state of each session, an additional parameter called a session priority is defined in accordance with an embodiment. The session priority of each session, which indicates active/standby status of each session, is included in the URSP (UE Route Selection Policy) and provided to the UE 300.

In accordance with an embodiment, to manage each session of the User Equipment (UE) as either an active or standby session and to distribute concentrated traffic based on the active or standby sessions of UE, UDR 101 performs operations as follows.

For example, UDR 101 performs: i) manages the gNB ID of the gNB through which the User Equipment (UE) 300 establishes a session connection; ii) monitors traffic usage in each session connected through the gNB; iii) if the traffic usage of the gNB exceeds a predetermined load threshold, adjusts the active-standby status of the UE 300's sessions connected to one exceeding the predetermined load threshold by modifying the session priority of each session. Accordingly, if UEs 300 become concentrated on specific gNBs 201 and 202 or UPFs 106 and 107, UDR 101 detects this situation and redistributes the traffic load to other standby sessions related to the specific gNB.

In accordance with an embodiment, UE Route Selection Policy (URSP) is used to manage and distribute network load in a 5G SA core network. URSP is a routing policy defined in the TS 23.503 specification and delivered to the User Equipment (UE) 300 by the core network 100. These rules determine how the UE selects the appropriate PDU session and network slice for different types of application traffic.

According to TS 23.503, URSP includes three components as shown in Table A below, and each component may be set with various parameters defined in Table B below.

TABLE A

| Information name | Description |
|---|---|
| Rule Precedence | Determines the order the |
| | URSP rule is enforced in the |
| | UE. |
| Traffic Descriptor | This part defines the Traffic descriptor components for |
| | the URSP rule. |
| List of | A list of Route Selection Descriptors. |
| Route Selection | |
| Descriptors | |

TABLE B

| Information | | |
|---|---|---|
| name | Parameter | Description |
| A traffic | Application | It consists of OSId and OSAppId(s). |
| descriptor | descriptors | |
| | IP descriptors | Destination IP 3 tuple(s) (IP address or IPv6 |
| | | network prefix, port number, protocol ID of |
| | | the protocol above IP). |
| | Non-IP descriptors | Descriptor(s) for destination information of |
| | | non-IP traffic |
| | DNN | This is matched against the DNN information |
| | | provided by the application. |
| | Connection | This is matched against the information |
| | Capabilities | provided by a UE application when it requests |
| | | a network connection with certain capabilities. |
| | Domain descriptors | FQDN(s) or a regular expression which are |
| | | used as a domain name matching criteria |
| A route | Route Selection | Determines the order in which the Route |
| selection | Descriptor | Selection Descriptors are to be applied. |
| descriptor | Precedence | |
| | SSC Mode Selection | One single value of SSC mode. |
| | Network Slice | Either a single value or a list of values of S- |
| | Selection | NSSAI(s). |
| | DNN Selection | Either a single value or a list of values of |
| | | DNN(s). |
| | PDU Session Type | One single value of PDU Session Type |
| | Selection | |
| | Non-Seamless | Indicates if the traffic of the matching |
| | Offload | application is to be offloaded to non-3GPP |
| | indication | access outside of a PDU Session. |
| | Access Type | Indicates the preferred Access Type (3GPP or |
| | preference | non-3GPP or Multi-Access) when the UE |
| | | establishes a PDU Session for the matching |
| | | application. |
| | PDU Session Pair | An indication shared by redundant PDU |
| | ID | Sessions as described in clause 5.33.2.1 of |
| | | TS 23.501 |
| | RSN | The RSN as described in clause 5.33.2.1 of |
| | | TS 23.501 |

In accordance with an embodiment, two components “A traffic descriptor” and “A route selection descriptor,” and corresponding parameters of each component are used.

For example, Table 1 below illustrates the components and parameters included in the URSP, used in embodiments.

TABLE 1

| | |
|---|---|
| A traffic descriptor | DNN(Data Network Name) |
| A route selection | PDU Session Pair ID, RSN(Redundancy Sequence |
| descriptor | Number) |

As shown in Table 1, the component ‘A traffic descriptor’ in the URSP includes the Data Network Name (DNN) as a parameter, while the component ‘A route selection descriptor’ contains the PDU Session Pair ID and the Redundancy Sequence Number (RSN).

In Table 1, the Data Network Name (DNN) is used to distinguish traffic within 5G networks. The PDU Session Pair ID is a pair identifier for redundant PDU session establishment. The Redundancy Sequence Number (RSN) is a sequence number used for redundant PDU session establishment. Using PDU Session Pair ID and RSN, a target session may be recognized in accordance with an embodiment.

For example, If the UE receives multiple URSP Rules that include the same PDU Session Pair ID, the UE will create multiple sessions according to the URSP Rules. Among these, sessions with the same PDU Session Pair ID, as specified by the “A route selection descriptor” of the URSP Rules, are established as redundant PDU Sessions. The redundant PDU Sessions created in this manner can be distinguished based on their RSN values.

After UE 300 connects to core network 100, the process of establishing a URSP-based session generally proceeds sequentially through the registration procedure, the UE policy association establishment procedure, and the PDU session establishment procedure. The registration procedure and the UE policy association establishment procedure are defined in the standards; therefore, detailed explanations are omitted.

In accordance with an embodiment, UDR 101 may store URSP Rule information with session priority information (e.g., Table 2) and forward the stored information to PCF 102. PCF 102 may generate a policy and charging control (PPC) rule (e.g., traffic forwarding rule and traffic drop rule or packet forwarding rule and packet drop rule) based on the URSP Rule including the session priority information. The created PPC rules may be delivered to UPS, and the URSP rule with session priority information may be delivered to the User Equipment (UE) 300 via AMF 103 and gNBs 201, 202. UE 300, upon receiving the URSP rule with the PPC rule, connects to core network 100 according to the URSP Rule with the session priority information to access 5G services.

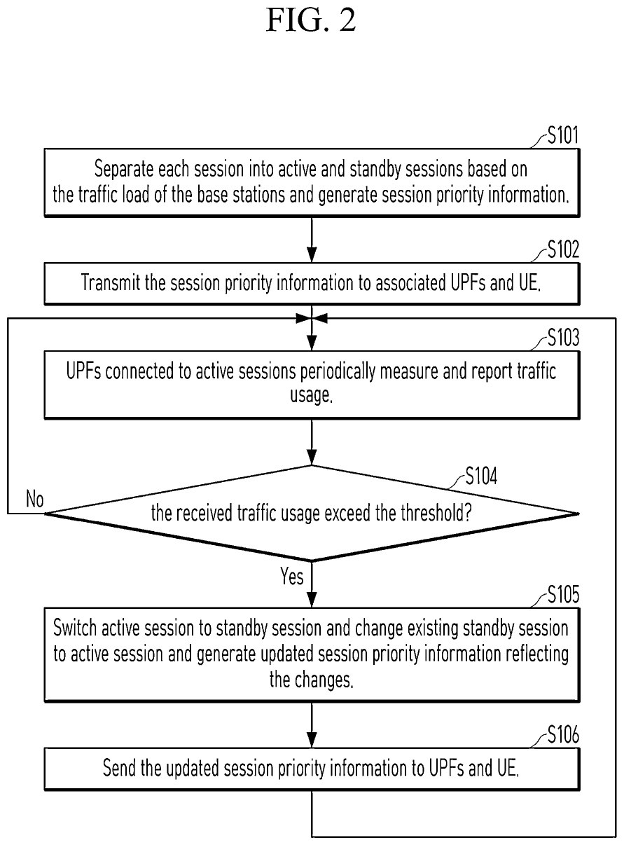

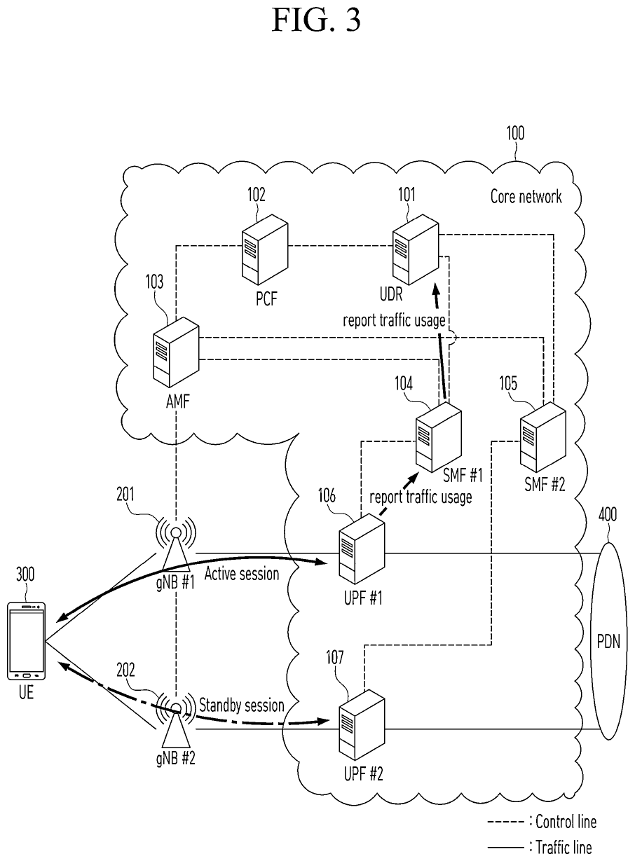

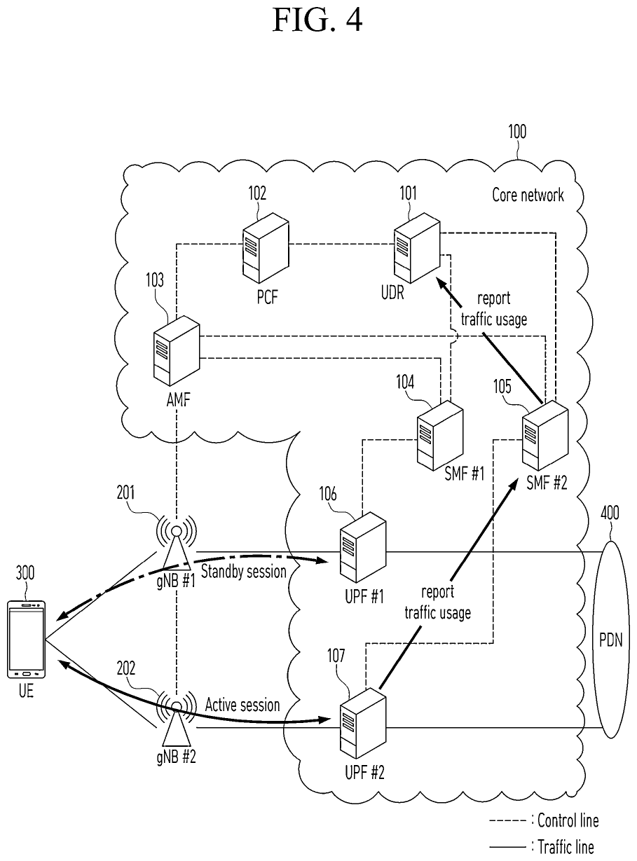

Hereinafter, a method for managing and distributing a network load using dual sessions of a UE in accordance with an embodiment will be described with reference to FIG. 2 to FIG. 10. FIG. 2 is a flowchart illustrating a method for managing and distributing network load in accordance with an embodiment. FIG. 3 is a diagram for explaining initially establishing an active session in accordance with an embodiment. FIG. 4 is a diagram for explaining switching an active session to a standby session in accordance with an embodiment.

Referring to FIG. 2, in PDU session establishment procedure, upon receiving a PDU session creation request from PCF, UDR 101 may classify sessions of UE 300 into an active session and a standby session based on the traffic load of corresponding gNBs 201 and 202, assign “1” as a session priority to the active session, and assign “2” as a session priority to the standby session, at step S101.

UDR 101 manages a URSP table as described below to regulate the traffic load of the gNBs. Table 2 represents the URSP table managed by UDR 101.

TABLE 2

| MDN | | | | |
|---|---|---|---|---|
| (Mobile | | | | |
| directory | URSP Rule | URSP Rule | | |
| Number) | Name | A traffic descriptor | A route selection descriptors | Session priority |
| 01011112222 | URSP #1 | DNN = DNN1 | PDU Session Pair ID = 1 | 1 |
| | | | RSN = 1 | |
| | URSP #2 | DNN = DNN2 | PDU Session Pair ID = 1 | 2 |
| | | | RSN = 2 | |
| 01022223333 | URSP #1 | DNN = DNN1 | PDU Session Pair ID = 1 | 1 |
| | | | RSN = 1 | |
| | URSP #2 | DNN = DNN2 | PDU Session Pair ID = 1 | 2 |
| | | | RSN = 2 | |
| 01044445555 | URSP #1 | DNN = DNN1 | PDU Session Pair ID = 1 | 1 |
| | | | RSN = 1 | |
| | URSP #2 | DNN = DNN2 | PDU Session Pair ID = 1 | 2 |
| | | | RSN = 2 | |

For each session of the User Equipment (UL), a URSP rule is identified by a unique URSP Rule name. As shown, the URSP rule may be defined by components such as a traffic descriptor and a route selection descriptor. The traffic descriptor includes the Data Network Name (DNN), while the route selection descriptor includes the PDU Session Pair ID and the Redundancy Sequence Number (RSN).

In accordance with an embodiment, the session priority is defined for indicating an active session and a standby session. For example, if a session is an active session, the Session priority is set to 1. If the session is a standby session, the Session priority is set to 2. If there are two or more multi-sessions, the Session priority can be assigned as 1, 2, 3, and so on, to indicate their priority levels.

In accordance with an embodiment, UDR 101 monitors and manages the traffic usage of gNBs connected to each UE by creating and maintaining a UE traffic management table, as shown in Table 3. Table 3 represents the UE traffic management table maintained by UDR 101.

TABLE 3

| | | Active gNB | Standby gNB | |
|---|---|---|---|---|
| # | MDN | ID | ID | Traffic Usage |
| 1 | 70111112222 | 1 | 2 | 0 GB |
| 2 | 81422223333 | 1 | 2 | 0 GB |
| 3 | 52344445555 | 1 | 2 | 0 GB |

According to Table 3, the “#” represents the number assigned to UE. MDN is an identifier that distinguishes UE 300 and may be a phone number assigned to UE 300. The Active gNB ID is the identifier of the base station that has formed an active session with corresponding UE. Traffic Usage is mapped to the traffic usage associated with corresponding UE. In this case, the traffic usage refers to the traffic transmitted and received through the active session.

UDR 101 aggregates the traffic usage of all UEs connected to each base station to calculate the traffic usage per a base station. Additionally, by aggregating the traffic usage of all UE, UDR 101 generates a base station traffic management table as shown in Table 4.

Through Table 4, UDR 101 may monitor the traffic usage at the base station level and compare the traffic usage of each base station (e.g., gNB) against its predetermined thresholds.

TABLE 4

| gNB ID | gNB Traffic usage | threshold |
|---|---|---|
| 1 | 0 GB | 100 GB |
| 2 | 0 GB | 100 GB |

In Table 4, the gNB traffic usage is the total sum of the usage from all UEs connected to a corresponding gNB. This is measured by UDR 101 on a gNB basis, as shown in Table 3, and this total usage is defined as the network load.

In accordance with an embodiment, UDR 101 may use Table 4 to check the traffic usage of each base station (e.g., gNB), set a session connected to a base station with relatively lower traffic usage as an active session, and set a session connected to the base station with relatively higher traffic usage as a standby session.

Furthermore, when the load exceeds a certain threshold, UDR 101 may change session priorities of the UE's sessions, allowing traffic to be handled by other gNBs (201, 202). Therefore, the network load may be redistributed and balanced, in accordance with an embodiment.

As described, Table 4 may be used to record the traffic usage of each base station (e.g., gNB) based on the traffic usage of all UEs connected to the respective base station (e.g., gNB), and UDR 101 may use Table 4 to classify each session to active or standby session and to determine whether to change a session priority or not in accordance with an embodiment.

In accordance with an embodiment, UDR 101 may transmit URSP rule information including the session priority information to PCF 102, and PCF 102 may create a PCC rule based on the received URSP rule information including the session priority information and send URSP rule information to the UE 300 at step S102. Additionally, PCF 102 may send the PCC rule to the UPFs 105 and 106 associated with the respective sessions. Here, the PCC rule may include one of a traffic forwarding rule and a traffic dropping rule according to the session priority of a corresponding session.

For example, UPF 105 and 106 may receive the PCC rule based on the session priority of the corresponding session. For example, UPFs 106 and 107 connected to active sessions may receive traffic forwarding rules, while UPFs 106 and 107 connected to standby sessions may receive traffic drop rules.

After S102, UE 300 may receive corresponding URSP rule with session priority information, determine an active session based on the RRC rules with session priority information, transmit and receive data through an active session in accordance with an embodiment.

At step S103, UPF that received the traffic forwarding rule as the PCC rule may periodically measure the traffic usage transmitted and received through the active sessions connected among UE 300, gNB #1 201, gNB #2 202, and UPF #1 106, UPF #2 107 and report the measured traffic usage associated with the active session to UDR 101 in accordance with an embodiment.

For example, UPF #1 106 may measure the traffic usage for each UE and report it to UDR 101. UDR 101 manages the traffic usage for each UE (e.g., Table 3) and aggregates the traffic usage at the base station level for the sessions to which the UEs are connected, managing it accordingly (e.g., Table 4). That is, UDR 101 receives the traffic usage of a predetermined UE from UPF 106 and determines the total traffic usage of the base station associated with the predetermined UE.

As shown in FIG. 3, UE 300 may establish two sessions. Between two sessions, a first session (UE 300 -gNB #1 201 -UPF #1 106) is set as an active session, and a second session (UE 300 -gNB #2 202 -UPF #2 107) is set as a standby session. In this case, the traffic from UE 300 is transmitted through the active session. UPF #1 106 periodically measures the traffic usage of the active session and sends the traffic usage report to SMF #1 104. Subsequently, SMF #1 104 forwards the traffic usage report to UDR 101.

In this case shown in FIG. 3, when traffic is generated from UE 300, the traffic is processed by UPF #1 106, where the active session has been established. During this process, UPF #1 106 measures the traffic usage.

Additionally, as shown in FIG. 1, FIG. 3, and FIG. 4, UDR 101 is connected to SMF #1 104 and SMF #2 105 through interfaces designed to receive traffic usage reports.

In accordance with an embodiment, UDR 101 may determine whether the total traffic usage of the corresponding base station exceeds a predetermined threshold at step S104. Such determination operation may be performed when UDR 101 receives the traffic usage report from corresponding UPFs. For example, UPF may report the traffic usage of the UE at predefined time intervals, such as every 3 minutes. The threshold may be set to 50 M-bits. However, both the time interval and the threshold can be adjusted based on variables in the surrounding communication environment.

If UDR 101 determines that the total traffic usage of corresponding base station does not exceed the threshold (No-S104), it returns to step S103 and continues to receive traffic usage reports from UPF.

On the other hand, if UDR 101 determines that the total traffic usage of corresponding base station exceeds the predetermined threshold (Yes-S104), UDR 101 may perform operations for balancing the network load at step S105.

In accordance with an embodiment, in the step S105, UDR 101 may i) select at least one of UEs associated with the base station that had the total traffic usage exceeds the predetermined threshold, ii) change the active session of the selected UEs to a standby session, and the standby session to an active session, and iii) update the URSP rule including the session priority information by reflecting the session priority changes.

For example, UDR 101 may select a UE that causes the total traffic usage of the base station to exceed a predetermined threshold among UEs associated with the base station. As another example, UDR 101 may select a UE that has been connected to the base station the longest or the one that connected most recently.

For switching the active session to the standby session vice versa, UDR 101 may change the session priority of the active session to “2” and change the session priority of the standby session to “1.”

At step S106, UDR 101 may send the URSP rule including the session priority information undated in the step S105 to the selected UE and associated UPFs, and PFC 102 may create the PCC rule updated based on the changed session priority information and send the PCC rule to the UPFs 105, 106 associated with the respective sessions.

Subsequently, UPF 105 associated with the active session periodically measures traffic usage and reports it to the UDR 101. Based on whether the traffic usage of the corresponding base station exceeds the threshold, UDR 101 repeats the process of selecting at least one UE among UEs connected to the base setation and switching between active and standby sessions of the selected at least one UE.

Referring to FIG. 4, a first session, which connects UE 300 to gNB #2 202 and UPF #2 107, may be a standby session, while a second session, which connects the UE 300 to gNB #1 201 and UPF #1 106, may be an active session. In this case, the traffic of UE 300 is transmitted through the active session. UPF #2 107 periodically measures the traffic usage of the active session and sends a traffic usage report to SMF #2 105. Then, SMF #2 105 forwards the traffic usage report to UDR 101.

At this point, when traffic is generated by the UE 300, the traffic is handled by UPF #2 107, where the active session is established. During this process, UPF #2 107 measures the traffic usage. Through this process, it is possible to prevent UEs from being concentrated on specific base stations (201, 202) and UPFs (106, 107), effectively achieving load balancing.

As explained above, in step S105, the UDR 101 determines whether the total traffic usage of a specific base station exceeds the threshold. If the threshold is exceeded, UDR 101 performs network load balancing. To achieve network load balancing, the UDR selects certain UEs associated with the base station that has exceeded the threshold. Then, among the sessions related to the selected UEs, at least one session is chosen, and the priority of the selected session is modified.

At this time, at least one or more UEs associated with the base station may be selected, and the embodiments are not limited to the selection method. Additionally, if there are two or more sessions associated with the selected base station, various methods may be used to choose the active session to be switched to a standby session. For instance, sessions may be selected in order of their RSN values, starting with the highest. However, the embodiments are not limited to such a selection method.

After modifying the session priority, UDR 101 may reset the traffic usage of the base station whose traffic load exceeded the threshold and reflect this update in Table 4. Then, UDR 101 may send URSP rule information including the updated session priority information to the selected UE and associated UPFs, and PCF 102 may create and send the PCC rule updated based on the changed session priority information to the UPFs 105, 106 associated with the respective sessions. Accordingly, UE 300 may use the updated URSP rule to select an active session to transmit data to and receive data from 5G core network 100 in accordance with an embodiment.

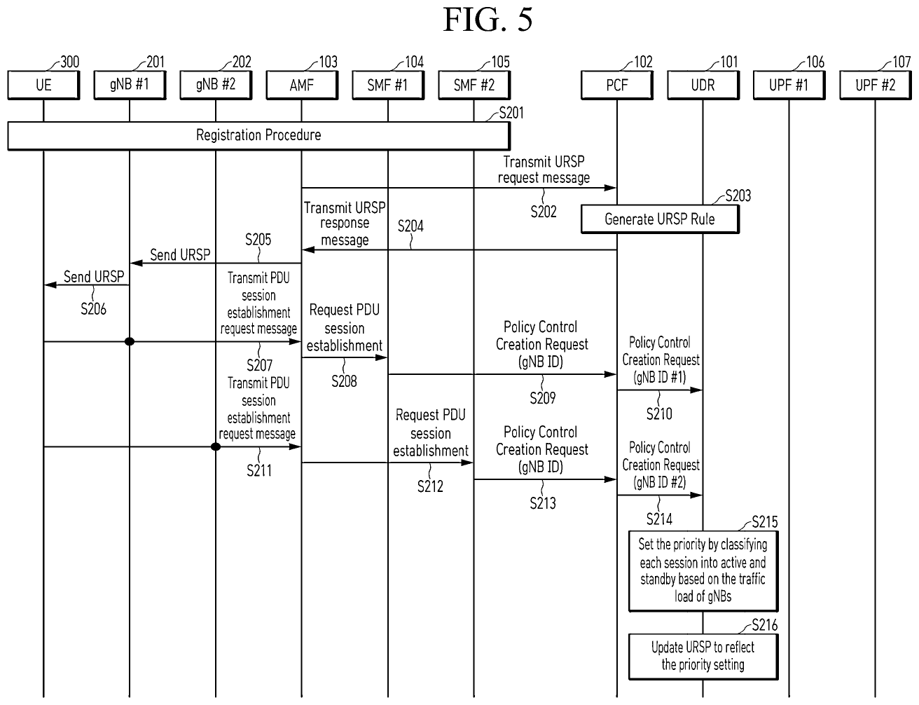

Hereinafter, each operation of the network load balancing method according to an embodiment will be described in more detail with reference to FIG. 5 to FIG. 10.

FIG. 5 illustrates a session establishment procedure according to an embodiment. Referring to FIG. 5, UE 300 may perform a registration procedure in coordination with gNB #1 201, AMF 103, and SMF #1 104 at step S201.

After registration, AMF 103 sends a URSP request message to PCF 102 for requesting PCF 102 to create URSP rules association with UE at step S202. The URSP request message may be Npcf_UEPolicyControl_Creat request.

At step S203, PCF 102 receives the URSP request message, obtains related information (e.g. user subscriptions or subscriber profile, policy information) from UDR 101 based on information (e.g., UE identifier), and generates URSP rules. At this time, URSP rules are created for each session of the UE, as shown in Table 2. For example, for UE 300, first and second URSP rules (URSP #1 and URSP #2) are generated.

For example, the first URSP rule (URSP #1) has the component “Traffic Descriptor” set to DNN1, and the component “A route selection descriptors” includes PDU Session Pair ID=1 and RSN=1. The second URSP rule (URSP #2) has the component “Traffic Descriptor” set to DNN2, and the component “A route selection descriptor” includes PDU Session Pair ID=1 and RSN=2.

At step S204, PCF 102 sends a URSP response message, which includes the generated URSP rules, to AMF 103. The URSP response message may be Npcf_UEPolicyControl_Create response.

At step S205, AMF 103 forwards the generated URSP rules to gNB #1 201. At step S206, gNB #1 201 delivers the URSP rules to UE 300.

At step S207, UE 300 sends a PDU Session Establishment Request message to AMF 103 via first gNB (gNB #1) 201. At step S208, AMF 103 obtains SMF selection information and sends a PDU Session Creation Request to first SMF (SMF #1) 104 selected based on the obtained SMF selection information.

At step S209, first SMF (SMF #1) 104 sends a policy control creation request, including first gNB ID (gNB #1 ID) with related UE ID, to PCF 102. Here, the policy control creation request may be Npcf SMPolicyControl_Create.

At step S210, PCF 102 forwards the policy control creation request, including the first gNB ID (gNB #1 ID) with related UE ID, to UDR 101.

At step S211, UE 300 also sends a PDU Session Establishment Request message to AMF 103 via second gNB (gNB #2) 202. The PDU session establishment request message may be PDU Session Establishment Request. At step S212, AMF 103 sends a PDU Session Creation Request to second SMF (SMF #2) 105.

At step S213, second SMF (SMF #2) 105 sends a policy control creation request, including second gNB ID (gNB #2 ID) with related UE ID, to PCF 102. At step S214, PCF 102 forwards the policy control creation request, including the gNB #2 ID with related UE ID, to UDR 101.

Here, steps S207 to S210 and steps S211 to S214 are executed in parallel simultaneously.

At step S215, in response to the policy control creation request from PCF, UDR 101 i) checks the traffic load in Table 4 based on the base station information (e.g., gNB ID included in the policy control creation request) received in steps S210 and S214, ii) based on the traffic load, classifies the first session connected between gNB #1 201 and UPF #1 106 and the second session connected between gNB #2 202 and UPF #2 107 into an active session and a standby session, and iii) sets a session priority for each session based on the classification.

For example, in step S215, if UDR 101 determines that the traffic load of gNB #1 201 is relatively lower than that of gNB #2 202, URD 101 sets the first session as the active session and the second session as the standby session. At this time, UDR 101 may set the session priority of URSP #1 for the first session to the value 1, indicating an active session, and set the session priority of URSP #2 for the second session to the value 2, indicating a standby session.

In step S216, UDR 101 may update the session priority information (e.g., priority setting result) to reflect the URSP rule table shown in table 2 configured in step S215.

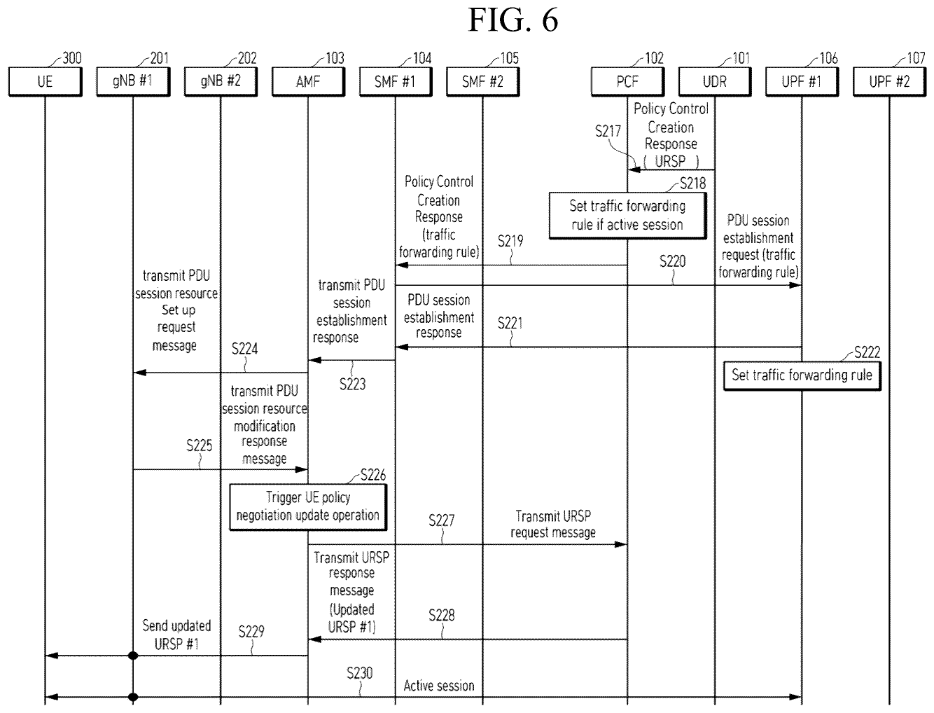

FIG. 6 illustrates an active session configuration procedure according to one embodiment. That is, FIG. 6 is a signal flowchart for explaining a process that occurs after updating the session priority information (e.g., into the URSP rule table) in step S216 of FIG. 5. Referring to FIG. 6, the active session configuration procedure will be described.

At step S217, UDR 101 sends a policy control creation response, including first URSP rule (URSP #1) with session priority information, to PCF 102 in response to the policy control creation request of step S210 in FIG. 5. For example, the policy control creation response may include information on URSP #1−Session priority=1.

At step S218, if PCF 102 determines that the session priority of the first URSP rule (URSP #1) indicates an active session, PCF 102 generates a traffic forwarding rule (e.g. packet forwarding rule) as a PCC rule. That is, when the session priority of the first URSP rule is 1, PCF 102 generates the traffic forwarding rule for the session associated with the first URSP rule.

At step S219, PCF 102 sends a policy control creation response (e.g., PCC rule), including the traffic forwarding rule (e.g., packet forwarding rule) from step S218 and the session priority information, to first SMF (SMF #1) 104 in response to the policy control creation request of step S209 in FIG. 5.

At step S220, first SMF (SMF #1) 104 sends a PDU Session Creation Request, including the received traffic forwarding rule to first UPF (UPF #1) 106. At step S221, first UPF (UPF #1) 106 sends a PDU Session Creation Response to first SMF (SMF #1) 104. At step S222, first UPF (UPF #1) 106 performs operations (e.g., creates a session) based on the traffic forwarding rule. For example, based on the traffic forwarding rule, first UPF 106 i) sets a session to allow the transmission and reception of traffic for UE 300 and ii) measures the traffic usage of UE 300 on the session and periodically reports the measured traffic usage to UDR 101.

At step S223, first SMF (SMF #1) 104 sends the PDU Session Creation Response to AMF 103 in response to the PDU Session Creation Request of step S208 in FIG. 5, and simultaneously, first SMF (SMF #1) 104 sends session priority information to AMF 103.

At step S224, AMF 103 sends a PDU Session Resource Modify Request message along with the session priority information to gNB #1 201. At step S225, AMF 103 receives a PDU session resource modification response message from gNB #1 201. When gNB #1 201 receives the session priority information (e.g., session priority=1), AMF 103 recognizes the first session established with gNB #1 201, UE 300, and UPF #1 106 as being in an active state.

At step S226, if AMF 103 receives the Session priority information along with the PDU session establishment response (including the Uplink Tunnel ID) in step S223, AMF 103 triggers a UE policy negotiation update operation. When the UE policy negotiation establishment operation is triggered, AMF 103 sends a URSP request message to PCF 102 at step S227.

At step S228, AMF 103 receives a URSP response message from PCF 102, which includes URSP #1 with the updated session priority. At step S229, AMF 103 sends the received URSP response message including the URSP #1 with the updated session priority to UE 300 through gNB #1 201. At step S230, according to the URSP #1 rule with the updated session priority, a session is established between UE 300 and UPF #1 106 through gNB #1 201, as an active session.

The session creation process involves establishing an uplink PDU session between UE 300 and UPF #1 106, sending a PDU session update request message from AMF 103 to SMF #1 104, conducting a PDU session update procedure (including the Downlink Tunnel ID) between SMF #1 104 and UPF #1 106, and creating a downlink PDU session between UE 300 and UPF #1 106. The detailed steps follow the standard definitions and are therefore omitted.

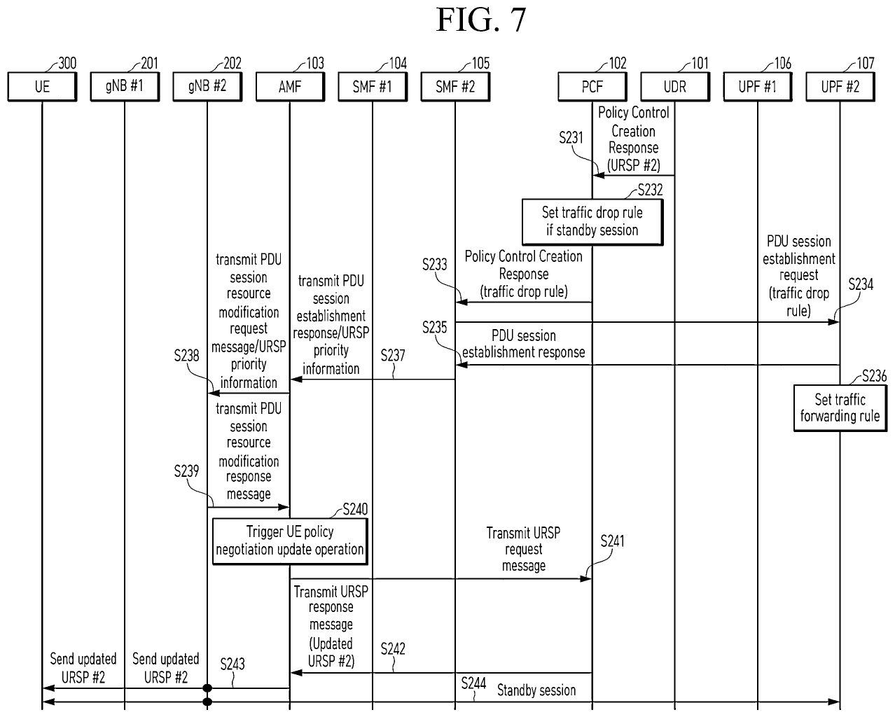

FIG. 7 illustrates a standby session establishment procedure according to one embodiment. That is, FIG. 7 is a signal flowchart for explaining a procedure following updating the session priority information in the URSP rule table (e.g., Table 2) step S216 of FIG. 5. Referring to FIG. 7, the standby session establishment procedure will be described in detail.

At step S231, UDR 101 sends a policy control creation response containing second URSP rule (URSP #2) with session priority information to the PCF 102 in response to the policy control creation request of step S214 of FIG. 5. For example, the policy control creation response may include information on URSP #2−Session priority=2.

At step S232, PCF 102 generates a traffic drop rule if PCF 102 determines that the session priority of the second URSP rule (URSP #2) indicates a standby session. That is, when the session priority of the second URSP rule is 2, PCF 102 generates the traffic drop rule for the session associated with the second URSP rule.

At step S233, PCF 102 sends a policy control creation response (e.g., PCC rule) including the traffic drop rule and the session priority information to SMF #2 105 in response to the policy control creation request of step S213 of FIG. 5.

At step S234, second SMF (SMF #2) 105 sends a PDU session creation request, which includes the traffic drop rule, to UPF #2 107. At step S235, second UPF (UPF #2) 107 responds to second SMF (SMF #2) 105 with a PDU session creation response. At step S236, second UPF (UPF #2) 107 applies the traffic drop rule, which blocks traffic transmission and reception for the UE 300. For example, based on the traffic drop rule, second UPF 107 sets a session not to allow the transmission and reception of traffic for UE 300.

At step S237, second SMF (SMF #2) 105 sends a PDU session creation response with the session priority information received from the PCF 102 to AMF 103 in response to the PDU session creation request of step S212 of FIG. 5.

At step S238, AMF 103 sends a PDU session resource modification request message and session priority information to second gNB (gNB #2) 202. At step S239, AMF 103 receives a PDU session resource modification response message from second gNB (gNB #2) 202. When second gNB (gNB #2) 202 receives the session priority information indicating 2 (e.g., Session priority=2), second gNB 202 recognizes the second session established with gNB #2 (202), UE (300), and UPF #2 (107) as being in a standby state.

At step S240, if AMF 103 receives Session priority information along with the PDU session creation response (e.g., Uplink Tunnel ID) in step S237, AMF 103 triggers a UE policy negotiation update operation. When the UE policy negotiation establishment operation is triggered, AMF 103 sends a URSP request message to PCF 102 at step S241.

At step S242, AMF 103 receives a URSP response message from PCF 102, including URSP #2 with the updated session priority. At step S243, AMF 103 sends the received URSP #2 with the updated session priority to UE 300 through gNB #2 202. At step S244, based on the URSP #2 rule, a session is established between UE 300 and UPF #2 107 through gNB #2 202 as a standby session. The session creation process may be the same as described in FIG. 7.

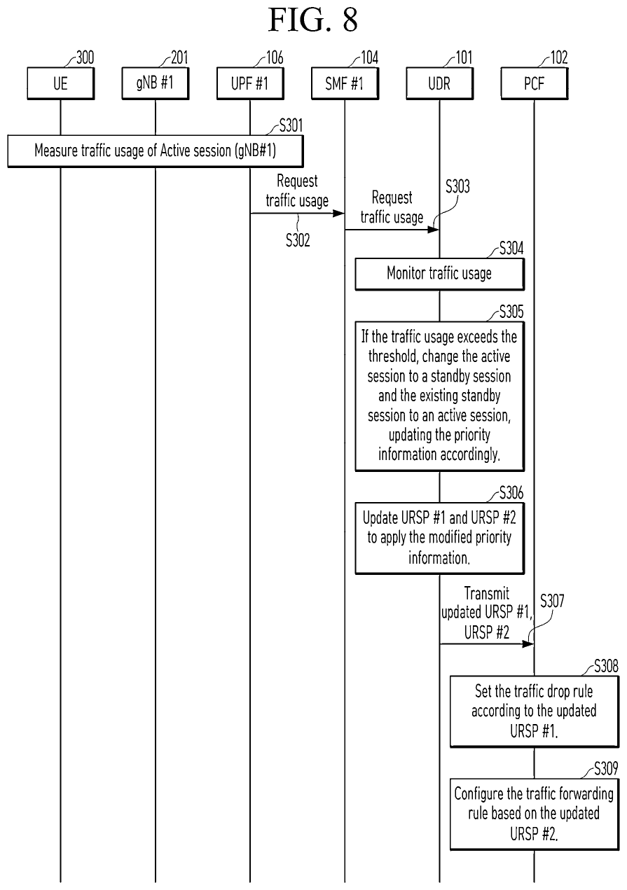

FIG. 8 illustrates a procedure for modifying session priority based on traffic usage reporting according to one embodiment. Referring to FIG. 8, the procedure for modifying session priority based on traffic usage reporting will be described.

At step S301, first UPF (UPF #1) 106 measures the traffic usage of UE 300 in the active session connected with first gNB (gNB #1) 201. At step S302, first UPF (UPF #1) 106 sends the measured traffic usage report to first SMF (SMF #1) 104. At step S303, first SMF (SMF #1) 104 forwards the traffic usage report to UDR 101.

At step S304, UDR 101 aggregates the traffic usage of UE 300 received through the report of step S303 on a per-base station basis and monitors each base station's traffic usage. At step S305, UDR 101 determines whether the base station's traffic usage exceeds a predetermined threshold. If the predetermined threshold is exceeded, UDR 101 modifies the priority information to switch the active session to the standby session vice versa.

At step S306, UDR 101 updates URSP rules, URSP #1 and URSP #2, for each session based on the modified priority information. For example, URSP #1, which is switched from the active session to the standby session, has its priority changed from 1 to 2, and URSP #2, which is switched from the standby session to the active session, has its priority changed from 2 to 1.

At step S307, UDR 101 sends the updated URSP #1 and URSP #2, which include updated session priority information, to PCF 102. At step S308, PCF 102 sets a traffic drop rule at the first session according to the updated URSP #1. At step S309, PCF 102 sets a traffic forwarding rule at the second session according to the updated URSP #2.

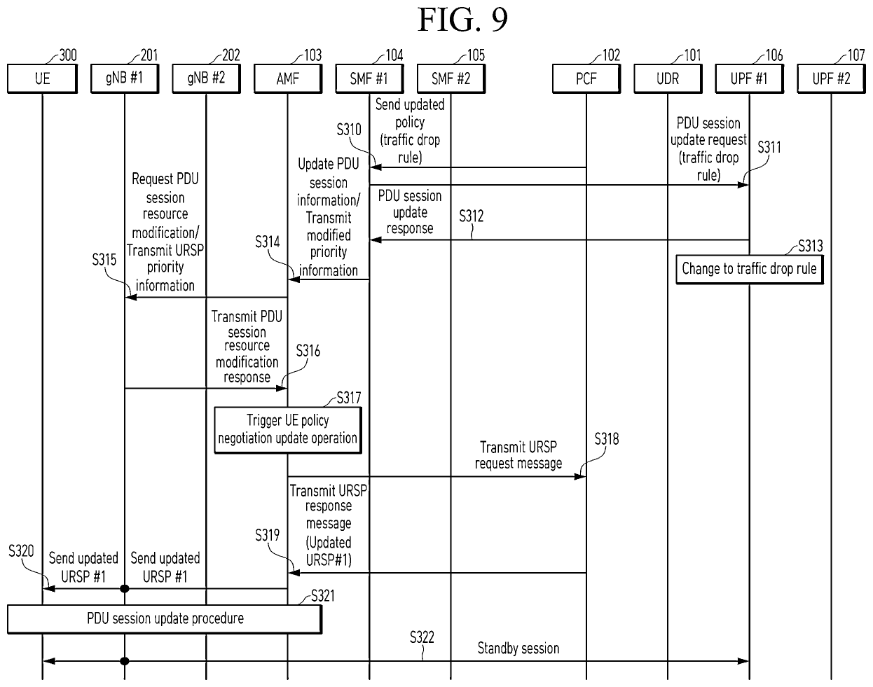

FIG. 9 illustrates a procedure for changing an active session to a standby session based on the modified session priority information according to one embodiment. Specifically, FIG. 9 represents the procedure following the step S309 of FIG. 8. Referring to FIG. 9, the procedure for changing an active session to a standby session based on the session priority information will be described.

After setting the sessions according to the updated URSP rules at step S309, the PCF 102 delivers the updated rules, including the traffic drop rule and the updated URSP rule (e.g., URSP #1), to first SMF (SMF #1) 104. At step S311, first SMF (SMF #1) 104 sends a PDU session update request with the traffic drop rule to UPF #1.

At step S312, first UPF (UPF #1) 106 sends a PDU session update response to first SMF (SMF #1) 104. At step S313, first UPF (UPF #1) 106 applies the traffic drop rule, blocking the transmission and reception of traffic through the session. By applying the traffic drop rule and setting the session as a standby session, first UPF (UPF #1) 106 stops processing traffic and no longer reports traffic usage to UDR 101.

At step S314, first SMF (SMF #1) 104 sends PDU session update information (e.g., PCC rule: traffic drop rule) and the updated session priority information (e.g., URSP rule with updated session priority) to AMF 103. At step S315, AMF 103 sends a PDU session resource modification request message with the updated session priority information (e.g., URSP rule with updated session priority) to first gNB (gNB #1) 201. At step S316, AMF 103 receives a PDU session resource modification response message from first gNB (gNB #1) 201. When first gNB (gNB #1) 201 receives the updated session priority indicating session priority=2, first gNB (gNB #1) 201 recognizes that the first session, established with gNB #1 201, UE 300, and UPF #1 106, has been changed to a standby state.

If AMF 103 receives the updated priority information along with the PDU session update information in step S314, it triggers the UE policy negotiation update operation at step S317. At step S318, once the UE policy negotiation update operation is triggered, AMF 103 sends a URSP request message to PCF 102. At step S319, AMF 103 receives a URSP response message from PCF 102, which includes the updated first URSP rule (URSP #1) including the updated session priority.

At step S320, AMF 103 sends the updated first URSP rule (URSP #1) to UE 300 via first gNB (gNB #1) 201. At step S321, UE 300 proceeds with the PDU session update procedure in coordination with gNB #1 and AMF 103. The details of this procedure follow standard definitions and are therefore omitted. At step S322, based on the first URSP rule (URSP #1), the session connected between UE (300), gNB #1 (201), and UPF #1 (106) is updated to a standby session.

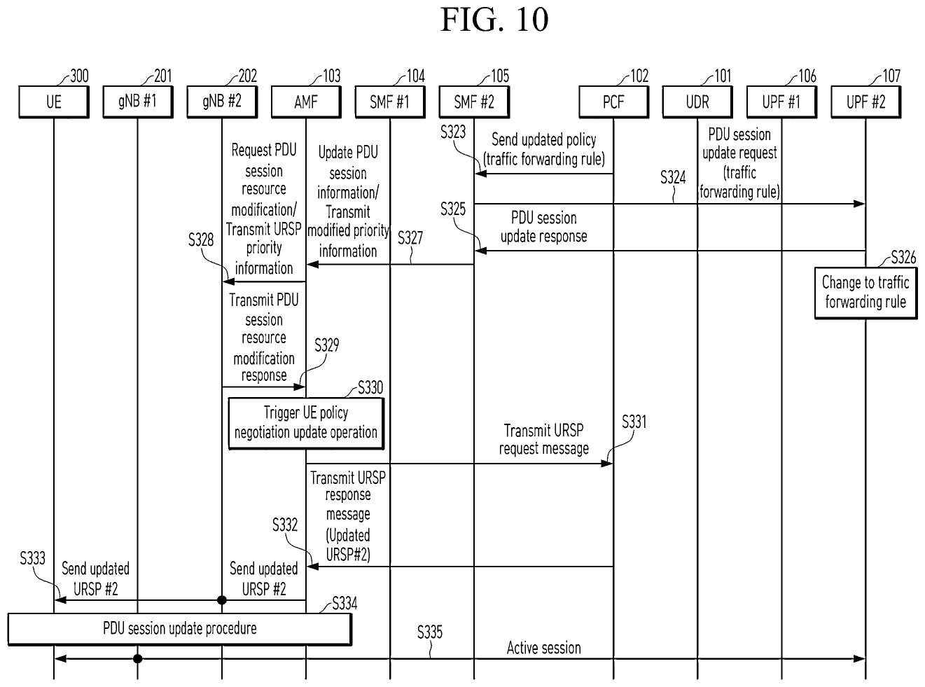

FIG. 10 illustrates the procedure for changing a standby session to an active session based on the modified session priority information according to one embodiment. Specifically, it represents the procedure following step S309 of FIG. 8. Referring to FIG. 10, the procedure for changing a standby session to an active session based on the modified session priority information will be described in detail.

After setting the sessions according to the updated URSP rules at step S309, PCF 102 delivers the updated rule, including the traffic forwarding rule and the updated URSP rule (e.g., URSP #2), to second SMF (SMF #2) 105. At step S324, second SMF (SMF #2) 105 sends a PDU session update request with the traffic forwarding rule to second UPF (UPF #2) 107.

At step S325, second UPF (UPF #2) 107 sends a PDU session update response to second SMF (SMF #2) 105. At step S326, second UPF (UPF #2) 107 applies the traffic forwarding rule, allowing it to process traffic transmission and reception through the session. By applying the traffic forwarding rule and setting the session as an active session, second UPF (UPF #2) 107 processes traffic and reports traffic usages to UDR 101.

At step S327, second SMF (SMF #2) 105 sends PDU session update information (e.g., PCC rule: traffic forwarding rule) and the updated session priority information (e.g., URSP rule with updated session priority) to AMF 103. At step S328, AMF 103 sends a PDU session resource modification request message with the updated session priority information (e.g., URSP rule with updated session priority) to second gNB (gNB #2) 202. At step S329, AMF 103 receives a PDU session resource modification response message from second gNB (gNB #2) 202. When second gNB (gNB #2) 202 receives the updated session priority information indicating session priority=1, second gNB (gNB #2) 202 recognizes that the second session, established with gNB #2 202, UE 300, and UPF #2 107, has been changed to an active state.

At step S330, if AMF 103 receives the updated priority information along with the PDU session update information in step S327, it triggers the UE policy negotiation update operation.

At step S331, once the UE policy negotiation update operation is triggered, AMF 103 sends a URSP request message to PCF 102. At step S332, AMF 103 receives a URSP response message from PCF 102, which includes the updated URSP rule (e.g., URSP #2 with the updated priority). At step S333, AMF 103 sends the updated URSP rule to UE 300 via second gNB (gNB #2) 202.

At step S334, UE 300 proceeds with the PDU session update procedure in coordination with gNB #2 and AMF 103. Details of this procedure follow standard definitions and are therefore omitted. At step S335, based on the URSP #2 rule, the session connected between UE 300, gNB #2 202, and UPF #2 107 is updated to an active session.

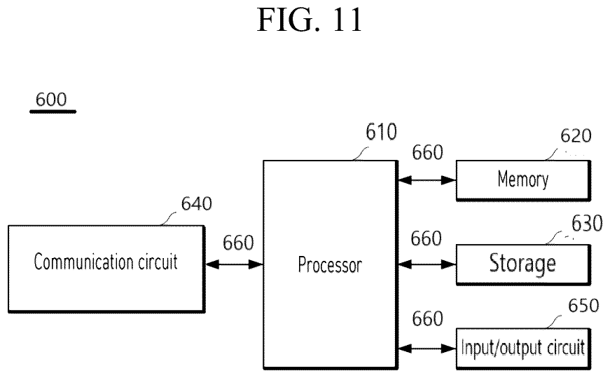

FIG. 11 is a block diagram illustrating the hardware configuration of network nodes including UDR or PCF and a UE according to one embodiment.

As described above, network nodes, such as UDR 101, PCF 102, AMF 103, first SMF (SMF #1) 104, second SMF (SMF #2) 105, first UPF (UPF #1) 106, second UPF (UPF #2) 107 may be an independent entity implemented on at least one physical or virtual computer server equipped with predefined software applications. That is, each network node may be computing device 600 in accordance with an embodiment. Furthermore, UE 300 may have similar configuration of computing device 600 in accordance with an embodiment.

Such a computing device 600 may include one or more processors 610, memory 620 that loads programs executed by the processor 610, storage 630 for storing programs and various data, a communication interface 640, an input/output circuit 650, and a bus 660 connecting these components. Additionally, the computing device 600 may include various other components.

When loaded into the memory 620, the program may include instructions that enable the processor 610 to perform the methods/operations according to various embodiments of the present disclosure. In other words, by executing these instructions, the processor 610 can carry out the methods/operations according to various embodiments of the present disclosure. The instructions refer to a set of computer-readable commands grouped by functionality, forming part of a computer program and executed by the processor.

The processor 610 controls the overall operations of each component of the computing device 600. The processor 610 may be configured to include at least one of a CPU (Central Processing Unit), MPU (Micro Processor Unit), MCU (Micro Controller Unit), GPU (Graphic Processing Unit), or any type of processor well-known in the technical field of the present disclosure. Additionally, the processor 610 can perform computations for at least one application or program to execute the methods/operations according to various embodiments of the present disclosure.

The memory 620 stores various data, commands, and/or information. To execute the methods/operations according to various embodiments of the present disclosure, the memory 620 may load one or more programs from the storage 630. The memory 620 may be implemented as volatile memory, such as RAM, but the technical scope of the present disclosure is not limited to this.

The storage 630 can non-temporarily store programs. The storage 630 may include non-volatile memory such as ROM (Read Only Memory), EPROM (Erasable Programmable ROM), EEPROM (Electrically Erasable Programmable ROM), flash memory, hard disks, removable disks, or any type of computer-readable recording medium well-known in the technical field of the present disclosure.

For example, the storage 630 may include at least one of an internal memory and an external memory according to embodiments. For example, memory 130 may be a flash memory, hard disk, multimedia card micro memory, SD or XD memory, Random Access Memory (RAM), Static Random-Access Memory (SRAM), Read-Only Memory (ROM), Programmable Read-Only Memory (PROM), Electrically Erasable Programmable Read-Only Memory (EEPROM), magnetic memory, magnetic disk, or optical disk, a SD card, a USB memory, but is not limited thereto.

The communication interface 640 supports the wired or wireless communication of the computing device 600. For this purpose, the communication interface 640 may be configured to include communication modules well-known in the technical field of the present disclosure.

For example, communication interface 640 may include at least one circuitry module (or at least one circuit) for communicating with other entities through core network 200 or directly communication with second device 400. Herein, the communication network may include a variety of communication networks such as a wireless communication network and a wired communication network. For example, the communication network may include a wideband code division multiple access (WCDMA) network, a microwave access (WiMAX) network, a wireless fidelity (WiFi) network, a long term revolution (LTE) network, x digital subscriber line (xDSL) network, a hybrid fiber-coaxial (HFC) network, a satellite network, a global system for mobile communication (GSM) edge radio access network (GERAN), a universal terrestrial radio access network (UTRAN), an evolved universal terrestrial radio access network (E-UTRAN), a wireless local area network (W-LAN), a public switched telephone network (PSTN), an integrated services for digital network (ISDN), an international mobile telecommunications (IMT)-2000 network, a wired area network (WAN), a local area network (LAN), a metropolitan area network (MAN), a cable television (CATV), third generation partnership project core networks (3GPP-CNs), an European telecommunications standards institute telecommunication & internet converged service & protocols for advanced networks core network (ETSI TISPAN CN), a 3GPP2 CN, a machine to machine (M2M) network, a broadcast network, a radio frequency identification (RFID) network, a near field communication (NFC) network, a ultra-wideband (UWB) network, a Bluetooth communication network, but the present disclosure is not limited thereto. In at least one embodiment, communication circuit 1300 may include at least one of a wireless communication circuit and a wired communication circuit. Herein, the wireless communication circuit and wired communication may be separately or integrally configured.

Input/output circuit 650 may include an input circuit as a user interface for receiving input from a user. For example, the input circuit may include any of a keypad, a dome switch, a touch pad, a jog wheel, and a jog switch, but is not limited thereto. Further, the input circuit may include several hardware key buttons. The hardware key buttons may include a hold key and a volume control button. Input/output circuit 650 may include an output circuit that includes a display panel and a circuit for controlling the display panel for visually outputting information processed by the processing circuit 610.

The bus 660 provides communication functionality among the components of the computing device 600. The bus 660 may be implemented in various forms, such as an Address Bus, Data Bus, and Control Bus.

In accordance with an embodiment display of output circuit 150 may display a graphs user interface that shows various information on second devices 400 and corresponding status of having the bidirectional communication service. The graphic user interface may be formed by executing a bidirectional communication service app installed in UE 100. Display of output circuit 150 may display i) second devices 400 currently connected to UE 100 but not yet setting up for the bidirectional communication service, ii) second devices 400 being connected to UE and communicating with other devices 500 through the bidirectional communication service, and iii) a current status of corresponding second device, such as a completion of bidirectional communication service or release from bidirectional communication service.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present disclosure can be embodied in the form of methods and apparatuses for practicing those methods. The present disclosure can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present disclosure can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present disclosure can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

No claim element herein is to be construed under the provisions of 35 U.S.C. § 112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

In this specification, when a part is described as “including” a component, it means that other components may also be included unless explicitly stated otherwise, rather than excluding other components.

Additionally, terms such as “ . . . unit,” “ . . . device,”and “ . . . module” used in the specification refer to units that process at least one function or operation and can be implemented as hardware, software, or a combination of both.

The devices described in the present invention comprise hardware such as at least one processor, memory, and communication device. The hardware is configured with the performance required to execute the methods of the invention. A program stored in conjunction with the hardware at a designated location executes the described operations of the invention. This program includes instructions implementing the methods described with reference to the drawings and is executed in combination with hardware such as a processor and memory.

In this specification, “transmission or provision” includes not only direct transmission or provision but also indirect transmission or provision through other devices or via alternative routes.

Expressions in the singular form can be interpreted as singular or plural unless explicitly stated otherwise with terms such as “one” or “single.”

Throughout the specification, identical reference numerals in the drawings refer to the same components regardless of the drawing. The term “and/or” includes any and all combinations of the mentioned components.

In this specification, ordinal terms such as “first” and “second” are used to describe various components but are not intended to limit the components. These terms are used solely to distinguish one component from another. For example, within the scope of this disclosure, a “first” component may be referred to as a “second” component, and similarly, a “second” component may be referred to as a “first” component.

In the flowcharts described with reference to the drawings, the order of operations may be altered, several operations may be merged or divided, and certain operations may be omitted.

What is claimed is:

1. A method of a user data repository (UDR) in a core network for balancing a network load, the method comprising:
classifying each of dual session of a user equipment (UE) established through base stations into an active session and a standby session based on traffic load of a corresponding base station, wherein the UE establishes the dual sessions to the core network, and the base stations includes a first base station and a second base station;
generating session priority information of each session according to the classification result; and
transmitting the session priority information of each session to the UE and at least one user plane function (UPF) connected to each session,
wherein the UE transmits data to and receive data from the core network using the active session among the multiple sessions established between the UE to the core network.

2. The method of claim 1, further comprising:
monitoring a traffic load of the first base station in an event of classifying a session connected through the first base station into an active session and another session connected through the second base station into a standby session;
in an event that the traffic load of the first base station exceeds a predetermined threshold, changing the active session connected to the first base station to a standby session, and changing the standby session of the second base station to an active session; and
updating the session priority information based on the changes and transmitting the updated session priority information to the UE and the at least one UPF.

3. The method of claim 2, further comprising:
transmitting the session priority information to policy control function (PCF) in the core network,
wherein the PCF sets a traffic forwarding policy based on the session priority information for a user plane function (UPF) connected to the active session, sets a traffic drop policy based on the session priority information for another UPF connected to the standby session, and transmits the traffic forwarding policy and the traffic drop policy to the UPFs.

4. The method of claim 3, wherein the UDR receives the traffic usages of the first base station or the second base setation according to the traffic forwarding policy from one UPF connected through the active session and monitor whether the traffic usage of each base station exceeds the predetermined threshold.

5. The method of claim 2, wherein:
the session priority information is transmitting to access and mobility management function (AMF) through the UDR and a session management function (SMF); and
the AMF, upon receiving the priority information, triggers a UE policy negotiation update operation to transmit the session priority information to the UE.

6. A method of a user plane function (UPF) in a core network for balancing a network load, the method comprising:
receiving a traffic forwarding policy from a policy control function (PCF) where the traffic forwarding policy is set by the PCF based on session priority information configured by a user data repository (UDR); and
monitoring a traffic usage of a base station connected to a user equipment (UE) through the active session and transmitting the monitored traffic usage to the PCF,
wherein when the UE establishes multiple sessions through two different base stations, the session priority information is information distinguishing the multiple sessions into an active session used for transmitting and receiving data and a standby session.

7. The method of claim 6, wherein the session priority information is generated by classifying each of multiple sessions of the UE established through base stations into an active session and a standby session based on traffic load of a corresponding base station, wherein the UE establishes multiple sessions to the core network, and the base stations includes a first base station and a second base station.

8. The method of claim 6, further comprising:
receiving a traffic drop policy from the PCF, wherein the traffic drop policy is set according to session priority information changed based on the traffic usage; and
upon receiving the traffic drop policy, stopping the monitoring of the traffic usages.

9. A method of a user equipment for balancing a network load in a core network, the method comprising:
establishing multiple sessions connected to a core network through at least two base stations including a first base station and a second base station;
receiving session priority information from the core network;
setting, as an active session, a session connected to the first base station among the multiple sessions based on the session priority information, and setting, as a standby session, a session connected to the second base station among the multiple sessions based on the session priority information; and
transmitting data to and receiving data from a packet data network (PDN) through the active session.

10. The method of claim 9, wherein the session priority information is configured based on traffic usages of the first base station and the second base station by user data repository (UDR).

11. The method of claim 9, wherein the session priority information is included in a field of a UE route selection policy (URSP) that the UE receives.

12. The method of claim 10, further comprising:
receiving an updated session priority information in an event that the traffic usage of the first base station exceeds a predetermined threshold; and
based on the updated session priority information, changing the session of the first base station to a standby session, and changing the session of the second to an active session.

13. The method of claim 12, wherein the updated session priority information is included in a field in updated UE route selection policy (URSP) received from the core network.

14. The method of claim 12, wherein the updated session priority information is received through UE policy negotiation update process from access and mobility management function (AMF).
